(19) United States
(12) Patent Application Publication
(10) Pub. No.: US 2021/0245331 A1
(43) Pub. Date: Aug. 12, 2021

(54) Pivoting Head Pliers

(71) Applicant: Donald Jacobs, Deltona, FL (US)

(72) Inventor: Donald Jacobs, Deltona, FL (US)

(21) Appl. No.: 16/840,658

(22) Filed: Apr. 6, 2020

Related U.S. Application Data
(60) Provisional application No. 62/972,447, filed on Feb. 10, 2020.

(51) Int. Cl. B25B 7/04; B25B 7/14

(52) U.S. Cl. CPC B25B 7/04; B25B 7/14

(57) ABSTRACT

A plier tool is described that can be used for removing connections or connectors in area that is difficult to get too because of the connection or connector mounted position. The tool will be used to position its gripping heads in different angles relative to its arms.

### BACKGROUND OF THE INVENTION

The pivoting head pliers pertains to a channel locking type pliers and a cannon plug pliers used to disconnect or connect connection or connector in an area requiring the gripping head to be at a different angel from the plier's arm. The pivoting head pliers gripping heads will be able to pivot in different angles from the arms.

In the industries such as aircraft, automobile, etc., and even in a household, there are many types of connections or connectors that require the use of a channel locking pliers and in the aircraft industry in particular, a cannon plug pliers is often used. These pliers are generally manufactured as a type of pliers with fixed straight gripping heads in reference to its arm. These types of channel lock or cannon plug pliers often cannot be use due to the position of a connection or in many cases on an aircraft you may have a cluster of connectors making it difficult to disconnect or connect a connector with the conventional cannon plug pliers. The present invention will obviate the afore mentioned disadvantages.

### BRIEF SUMMARY OF INVENTION

The primary object of the present invention is to enable the user to position the gripping heads of a channel lock or cannon plug pliers at different angles in reference to its arm for easier accessibility to a connection or connector to disconnect or connect. The gripping heads will pivot on a pin that connects between both the heads and arms. The pin holds the heads and arms together. The positioning of both heads, after the desired angle is obtained, will be able to lock in its position. The locking mechanism will be between the Pliers arms and gripping heads. The locking feature detailed in the present invention assure both heads are at the same angle and it also adds to the stability of the use of the present invention.

### BRIEF DESCRIPTION OF THE DRAWINGS

FIG. 1: is a Side View of the Pivoting Head Pliers

FIG. 2: is a View Showing the Rotational Axis of the Pivoting Head Pliers

FIG. 3: is a Cross Section of the Lock Release and Gripping Head

FIG. 4: is a Top View of the Gripping Head and Lock Release

FIG. 5: is a Cross Section of a Spring Embodiment with Flat Spring

FIG. 6: is a Cross Section of a Spring Embodiment with single Compression Spring

FIG. 7: is a Cross Section of a Spring Embodiment with dual Compression Spring

FIG. 8: is a Side View of the Pivoting Head Pliers for the Spring Loading Ball Bearing Locking Mechanism

FIG. 9: is a Cross Section of the Spring Loading Ball Bearing Locking Mechanism and Gripping Head

FIG. 10: is a Top View of the Gripping Head and Spring Loading Ball Bearing Locking Mechanism with cavity in Arm for Spring

FIG. 11: is a Cross Section of a Spring Embodiment for Spring Loading Ball Bearing Locking Mechanism

FIG. 12: is a View showing the Rotational Axis of the Pivoting Head Pliers for the Spring Loading Ball Bearing Locking Mechanism

### DETAILED DESCRIPTION OF INVENTION

The following provides a detailed description of various drawings of the present invention. Each of the drawing explains the invention and are not to be limited for those skilled in this art. Various modifications or variations may be made in the present invention without changing the scope of the present invention.

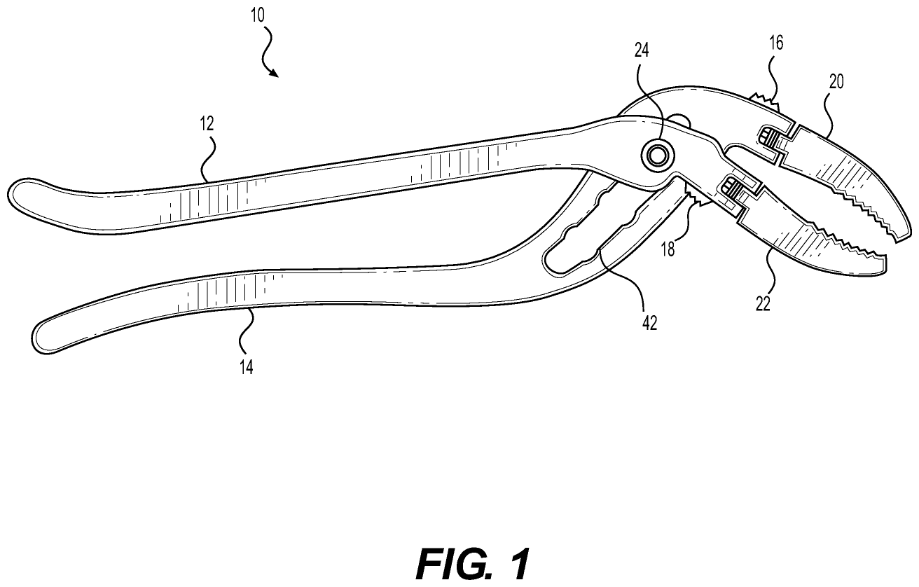

Referring to the drawings and initially to FIGS. 1 and 8, the channel lock pliers or the cannon plug plies is used to disconnect or connect a connection or connector. The pliers (10), in-regards to the present invention comprises of two arms (12) and (14) pivotally joined by a pivotal shaft (24). A first gripping head (20) and a second gripping head (22) are respectively pivotally connected to the front end of the first arm (14) and the second arm (12). The first arm (14) has an elongated through hole (42) and the second arm (12) has a pivotal pin (24) that allows the second arm (12) to rotate. The second arm (12), when rotated clockwise on its axis, will be able to adjust into the first arm (14) through hole (42) and lock into position when it's rotated counterclockwise. This action between the first arm (14) and the second arm (12) will allow the first gripping head (20) and the second gripping head (22) to expand for a wider gripping surface.

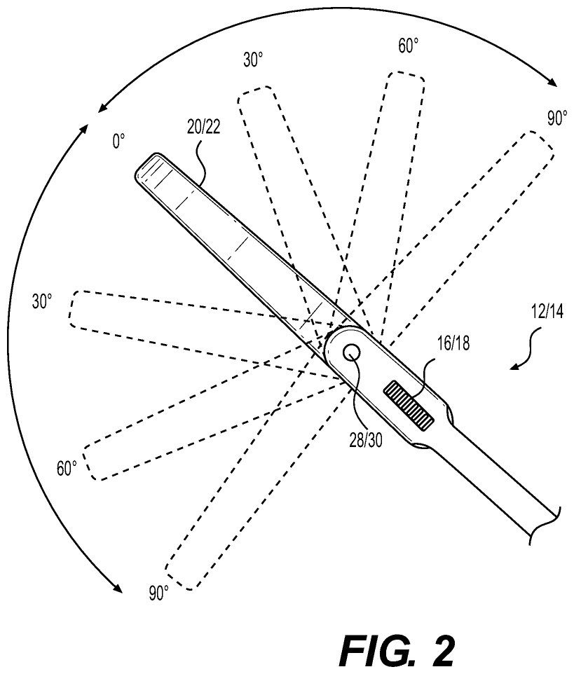

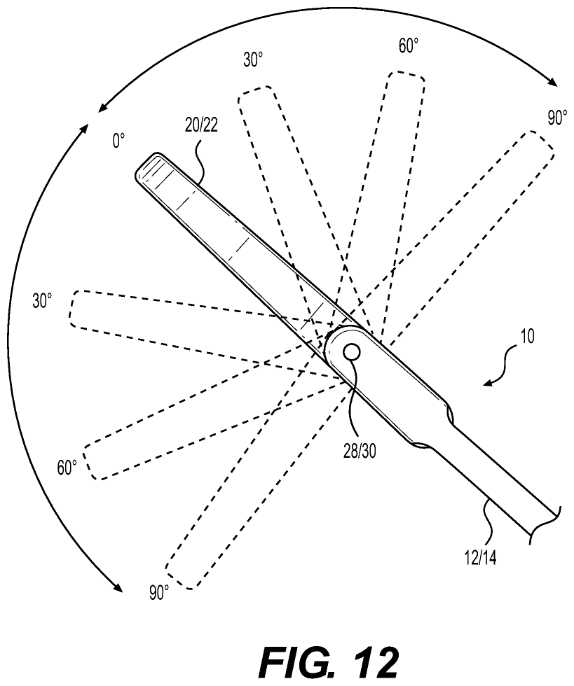

With reference to FIGS. 2 and 12, the first gripping head (20) will be able to pivot on a pin (28) that joins the first arm (14) and the first gripping head (20) together. The first gripping head (20) will be able to pivot at different degrees in the clockwise or counterclockwise position. The second gripping head (22) will also be able to pivot on a pin (30) that joins the second arm (12) and the second gripping head (22) together. The second gripping head (22) will be able to pivot at different degrees in the clockwise and counterclockwise position.

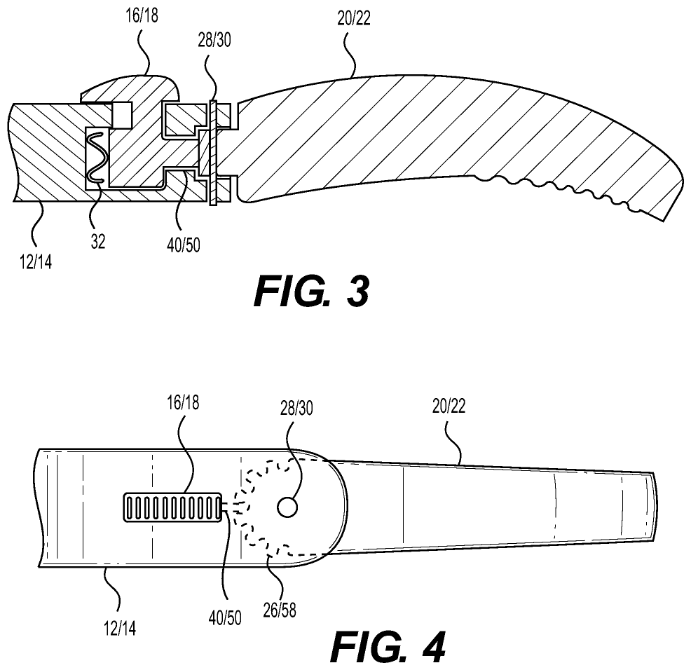

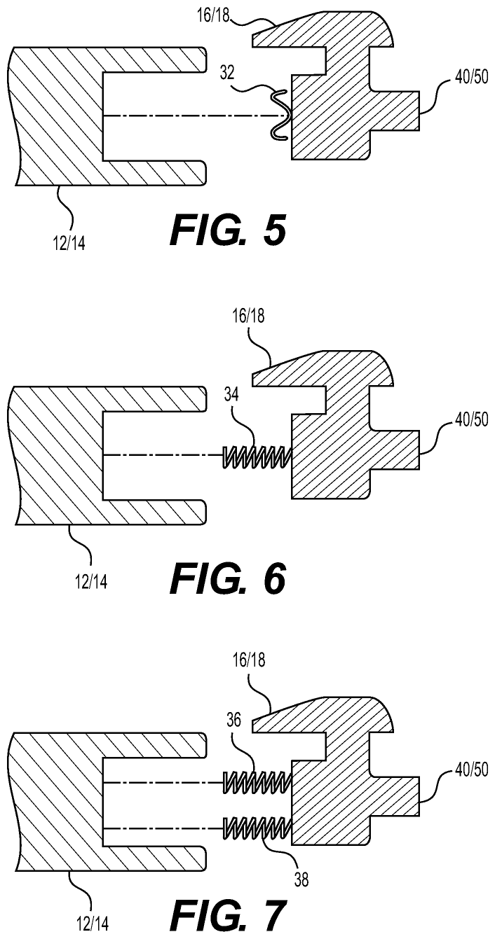

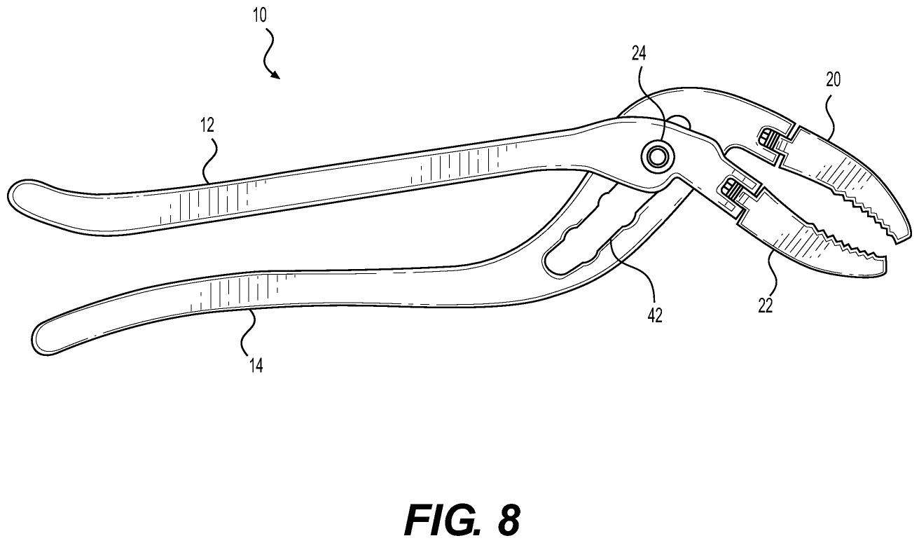

With reference to FIGS. 1-7, the first dual action locking embodiment (16) is inserted into a cavity forward of the first arm (14) with a flat spring (32) or single compression spring (34) or double compression springs (36) and (38) between the aft side of the first dual action locking embodiment (16) and the inside of the cavity of the first arm (14). The first dual action locking embodiment (16) and the first arm (14) cavity will have square shapes and angles cut out to allow the first dual action locking embodiment (16) to be maneuver freely inside of the first arm (14) cavity. The first action of the first dual action embodiment (16) is moving the spring loaded first dual action embodiment (16) aft, riding along the top forward side of the first arm (14). This first action will temporarily release, while the user is holding the top side of the first dual action embodiment (16), the forward side of the first dual action locking embodiment (16) plunger (40) from the aft side of the first gripping head (20) detents (26). By releasing the forward side plunger (40) of the dual action locking embodiment (16) out of the aft side first gripping head (20) detents (26), the first gripping head (20) will be able to pivot in the desired angle by the user. The second action of the first dual action locking embodiment (16), after the desired angle of the first gripping head (20) is achieved by user, the first dual action locking embodiment (16) can be released by user allowing the first dual action locking embodiment (16) to automatically spring forward. The second action of the first dual action locking embodiment (16) also includes, the first dual action locking embodiment (16) forward side plunger (40) being inserted into the aft side of the first gripping head (20) desired angle detent (26). The first and second action of the first dual action locking embodiment (16), will lock the first gripping head (20) at a desired angle in relation to the first arm (14). The second dual action locking embodiment (18) is inserted into a cavity forward of the second arm (12) with a flat spring (32) or single compression spring (34) or double compression springs (36) and (38) between the aft side of the second dual action locking embodiment (18) and the inside of the cavity of the second arm (12). The second dual action locking embodiment (18) and the second arm (12) cavity will have square shapes and angles cut out to allow the second dual action locking embodiment (18) to be maneuver freely inside of the second arm (12) cavity. The first action of the second dual action embodiment (18) is moving the spring loaded second dual action embodiment (18) aft, riding along the bottom forward side of the second arm (12). This first action will temporarily release, while the user is holding the top gripping side of the second dual action embodiment (18), the forward side of the second dual action locking embodiment (18) plunger (50) from the aft side of the second gripping head (22) detents (58). By releasing the forward side plunger (50) of the second dual action locking embodiment (18) out of the aft side second gripping head (22) detents (58), the second gripping head (22) will be able to pivot in the desired angle by the user. The second action of the second dual action locking embodiment (18), after the desired angle of the second gripping head (22) is achieved by user, the second dual action locking embodiment (18) can be released by user allowing the second dual action locking embodiment (18) to automatically spring forward. The second action of the second dual action locking embodiment (18) also includes the second dual action locking embodiment (18) forward side plunger (50) being inserted into the aft side of the second gripping head (22), after being released by user, into the desired angle detent (58). The first and second action of the second dual action locking embodiment (18), will lock the second gripping head (22) at a desired angle in relation to the second arm (12).

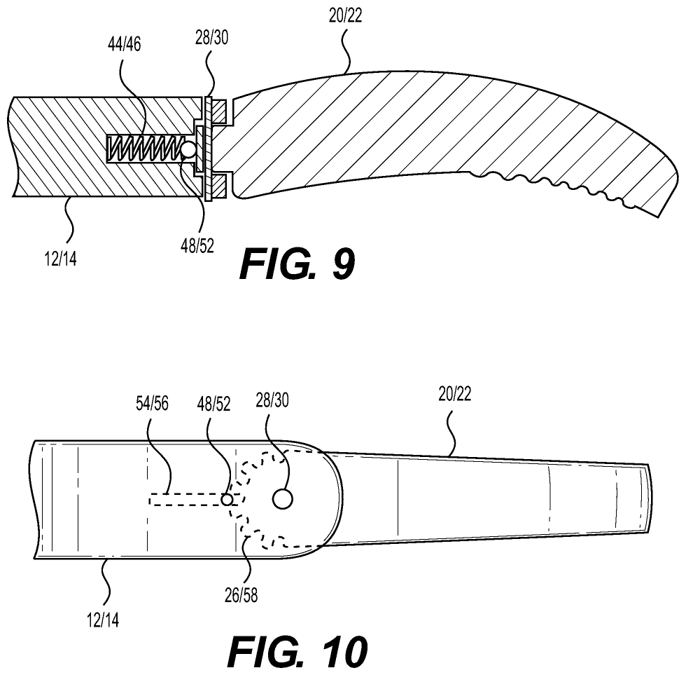

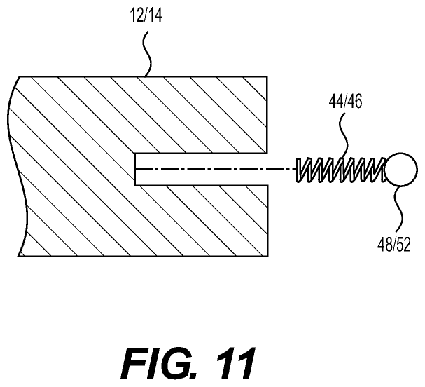

With reference to FIGS. 9-11, the first single action locking compression spring (44) and the ball bearing (48) is inserted into a cavity (54) forward of the first arm (14). The compression spring (44) is inserted first into the forward side of the first arm (14) cavity (54) and the ball bearing (48) is inserted second against the compression spring (44). After the compression spring (44) and the ball bearing (48) is inserted into the forward side of the first arm (14) forward cavity (54), the first gripping head (20) is attached to the first arm (14) with a pivotal pin (28). When the first gripping head (20) is attached to the first arm (14), the aft side of the first gripping head (20) detent (26) will compress the ball bearing (48) and compression spring (44) into the cavity (54). The ball bearing (48), when seated into the aft side of the first gripping head (20) detent (26) will lock the first gripping head (20) into the desired angle. The only action required to pivot the first gripping head (20) at a different angle in relation to the first arm (14), is by the user holding the first gripping head (20) and pivoting the first gripping head (20) by force against the ball bearing (48) and compression spring (44), then releasing the first gripping head (20) when desired angle is achieved. When the user releases the first gripping head (20), after desired angle is achieved, the ball bearing (48), compressed by the compression spring (44), will lock into another angled detent (26). The second single action locking compression spring (46) and the ball bearing (52) is inserted into a cavity (56) forward of the second arm (12). The compression spring (46) is inserted first into the forward side of the second arm (12) cavity (56) and the ball bearing (52) is inserted second against the compression spring (46). After the compression spring (46) and the ball bearing (52) is inserted into the forward side of the second arm (12) forward cavity (56), the second gripping head (22) is attached to the second arm (12) with a pivotal pin (30). When the second gripping head (22) is attached to the second arm (12), the aft side of the second gripping head (22) detent (58) will compress the ball bearing (52) and compression spring (46) into the cavity (56). The ball bearing (52), when seated into the aft side of the second gripping head (22) detent (58) will lock the second gripping head (22) into the desired angle. The only action required to pivot the second gripping head (22) at a different angle in relation to the second arm (12), is by the user holding the second gripping head (22) and pivoting the second gripping head (22) by force against the ball bearing (52) and compression spring (46), then releasing the second gripping head (22) when desired angle is achieved. When the user releases the second gripping head (22), after desired angle is achieved, the ball bearing (52), compressed by the compression spring (46), will lock into another angled detent (58). In the scope of the present invention, the user will pivot both the first gripping head (20) and the second gripping head (22) at the same desired angle. The design of the aft side first gripping head (20) detent (26) and the aft side of the second gripping head (22) detent (58) will allow the locking of both the first gripping head (20) and the second gripping head (22) to be symmetrical.

The claimed invention is:

1. A pair of pivotal head channel locking pliers or cannon plug pliers comprising of: A first arm having an elongated through hole with a pivotal head. The second arm having a pivotal pin with a pivotal head. Both the first arm and the second arm are joined-together with the second arm pivotal pin inside of the first arm elongated through hole. The first and second arms, when joined by the pivotal pin, will allow the second arm to rotate clockwise or counterclockwise on its axis. The first arm has a pivotal gripping head, joined by a pin, that allows the first gripping head to pivot at different degrees in respect to the first arm. The second arm also has a pivotal gripping head, joined by a pin, that allows the second gripping head to pivot at different degrees in respect to the second arm. When the second arm is rotated clockwise, this will allow the second arm to unlock its position inside of the first arm elongated through hole and move up or down inside the first arm elongated through hole. When the second arm is rotated clockwise, and moved down the first arm elongated through hole, and then rotated counterclockwise, this will lock the second arm into a position which would give the first and second gripping heads a wider gripping surface.

2. The device of claim 1 further comprising a mechanism for releasing and locking the gripping heads into their desired angle.

3. The device of claim 2 wherein said release and locking comprises of several different locking mechanisms.

4. One of the devices of claim 3 wherein said release and locking comprises of a two-stage release and locking embodiment spring loaded with a flat spring between the release and locking embodiment and forward of the first arm. The release and locking embodiment and spring is in a cavity between the first arm and the first gripping head. A two-stage release and locking embodiment spring loaded with a flat spring between the release and locking embodiment and forward of the second arm. The release and locking embodiment and spring is in a cavity between the second arm and the second gripping head.

5. Another device of claim 3 wherein said release and locking comprises of a two-stage release and locking embodiment spring loaded with a one compression spring between the release and locking embodiment and forward of the first arm. The release and locking embodiment and spring is in a cavity between the first arm and the first gripping head. A two-stage release and locking embodiment spring loaded with one compression spring between the release and locking embodiment and forward of the second arm. The release and locking embodiment and spring is in a cavity between the second arm and the second gripping head.

6. Another device of claim 3 wherein said release and locking comprises of a two-stage release and locking embodiment spring loaded with a dual compression spring between the release and locking embodiment and forward of the first arm. The release and locking embodiment and spring is in a cavity between the first arm and the first gripping head. A two-stage release and locking embodiment spring loaded with dual compression spring between the release and locking embodiment and forward of the second arm. The release and locking embodiment and spring is in a cavity between the second arm and the second gripping head.

7. Another device of claim 3 wherein said release and locking comprises of a single stage release and locking mechanism.

8. The device of claim 7 wherein said release and locking comprises a single compression spring and ball bearing inserted into a cavity forward of the first arm. The compression spring and ball bearing is in a cavity between the first arm and the first gripping head. A single compression spring and ball bearing inserted into a cavity forward of the second arm. The compression spring and ball bearing is in a cavity between the second arm and the second gripping head.

9. The device of claim 2 wherein said release and locking comprises a first and second gripping head both having symmetrical detent aft of the gripping heads for precision angle adjustment.
